(19) United States
(12) Patent Application Publication
(10) Pub. No.: US 2004/0080537 A1
(43) Pub. Date: Apr. 29, 2004

(54) Stand-alone monitor as photograph slide show projector

(76) Inventor: Glenn Adler, Redwood City, CA (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/687,363

(22) Filed: Oct. 15, 2003

Related U.S. Application Data
(62) Division of application No. 09/663,586, filed on Sep. 18, 2000.

(51) Int. Cl. G09G 5/00

(52) U.S. Cl. 345/764

(57) ABSTRACT

A stand-alone monitor for viewing high-resolution digital images without the need of a PC including a means for transferring digital images directly to the stand-alone monitor; a means for displaying the digital images on a display screen of the stand-alone monitor; and a means for controlling the transfer and display of the digital images on the display screen. In one embodiment the images are received from a wireless image source, such as a digital camera. In another embodiment the images are read from an electronic storage media, such as smart media. The viewing of images on the monitor is controlled by a user, via a keypad or remote control, for instance. The keypad and reader/receiver may be integrated directly into the monitor or implemented as an interface within a separate enclosure.

### BACKGROUND OF THE INVENTION

1. Field of the Invention

The present invention relates to a stand-alone monitor, and more particularly to a means for displaying a digital photograph file image on a stand-alone monitor directly without the need of a personal computer.

2. Description of the Related Art

Digital photography has increased significantly in popularity recently. Increasing numbers of consumers are discovering the many advantages provided by the digital photography medium, such as increased convenience, immediate viewing of photographs, economy, and photographic editing capabilities.

Digital cameras, or camcorders with digital photograph capabilities, store photographic images as a digital photograph file in an electronic storage medium, such as flash memory. The image is typically available for viewing, on a color liquid crystal display (LCD) included with the camera. A user conveniently views the digital image after taking the picture and has the option of deleting any undesired images after storage within the electronic storage medium.

The LCD size is limited due to the compact nature of the digital camera. For this reason, a user will typically transfer the image to a personal computer (PC), using either a cable or some other suitable means, for viewing on a computer monitor. Some digital cameras allow users to transfer the images to a television for viewing. The monitor, or television, provides a significantly larger viewing area to view the digital photographic images (images hereinafter), allowing the user to view the images in more detail, and in the case of a PC, optionally store the images within the PC for later retrieval and editing as desired.

However, there are some disadvantages to viewing the images via a PC. First, the user is obviously required to have a PC, and the PC must have a suitable interface to allow transfer of the images from the camera to the PC. Second, the user is required to boot up the PC and load specialized software on the PC to enable downloading and viewing the images, resulting in an inconvenient delay. Third, the user is required to learn various keyboard and/or mouse commands to navigate through the images.

There are also disadvantages to viewing the images on a television. A television offers poor resolution, thereby countering the main reason for seeking larger display capability.

Still another alternative requires a user to purchase a dedicated viewing device. However, the viewing devices are relatively expensive and limited to the single task of viewing the images, making them cost prohibitive to the average consumer.

### SUMMARY OF THE INVENTION

It is therefore an object of the present invention to provide a stand-alone monitor with an interface to transfer and view high-resolution photographic images directly (without the need for a PC).

It is another object of the present invention to provide a stand-alone monitor to view high-resolution photographic images in a convenient, time saving, cost effective manner.

To achieve the above objects, a stand-alone monitor in accordance with the present invention includes an interface that controls the transfer of digital images directly to the stand-alone monitor; and a display screen that displays the transferred digital images in accordance with user commands entered via a suitable user-interface. The user-interface comprises, e.g., a keypad, a mouse or touch screen functionality, preferably in combination with a suitable interactive graphical menu.

In one embodiment, the images are received by the interface from a wireless image source, such as a digital camera. In another embodiment the images are read by the interface from an electronic storage medium, such as compact flash or a hard-disk drive (HDD). The viewing of images on the monitor is controlled by a user, e.g., via a keypad on the interface, and/or remotely when wireless communication is employed.

In another embodiment of the invention, a stand-alone monitor has an interface that comprises an electronic storage medium reader that reads digital images stored on an electronic storage medium. A controller processes and transfers the read digital images for display on a display screen of the stand-alone monitor, and a keypad issues commands to the controller to control the reading and display of the digital images on the display screen. The controller described is application specific, tailored to address the functions of user interface, image data manipulation on the medium and display, as opposed to a general purpose CPU and operating system. The keypad and reader/receiver may be integrated directly into the monitor or implemented as an interface within a separate enclosure. Since a digital monitor typically has an onboard controller and optionally a frame buffer, the invention preferably shares these resources with the functionality to render the digital images on the stand-alone monitor.

### BRIEF DESCRIPTION OF THE DRAWINGS

The above and other objects, features, and advantages of the present invention will become more apparent in light of the following detailed description of an exemplary embodiment thereof taken in conjunction with the attached drawings in which:

FIG. 1 illustrates a stand-alone monitor in accordance with one embodiment the present invention;

FIG. 2 illustrates a stand-alone monitor in accordance with another embodiment of the present invention;

FIG. 3 illustrates a stand-alone monitor in accordance with still another embodiment of the present invention;

FIG. 4 illustrates a stand-alone monitor in accordance with yet another embodiment of the present invention;

FIG. 5 is a block diagram illustrating a storage device interface in accordance with the present invention;

FIG. 6 is a block diagram illustrating a wireless communication interface in accordance with the present invention;

FIG. 7 is a block diagram illustrating a storage device interface with remote control capabilities in accordance with the present invention; and

FIG. 8 is a block diagram illustrating a wireless communication interface in a separate enclosure in accordance with the present invention.

### DETAILED DESCRIPTION OF THE PREFERRED EMBODIMENT

Turning now to the drawings, in which like reference numerals identify similar or identical elements throughout the several views and commonly known components and functions are omitted to avoid obscuring the invention, a stand-alone monitor in accordance with the present invention includes an interface that controls the transfer of digital images directly to the stand-alone monitor and a display screen that displays the transferred digital images in accordance with user commands entered via a keypad or other suitable user-input means included with the interface.

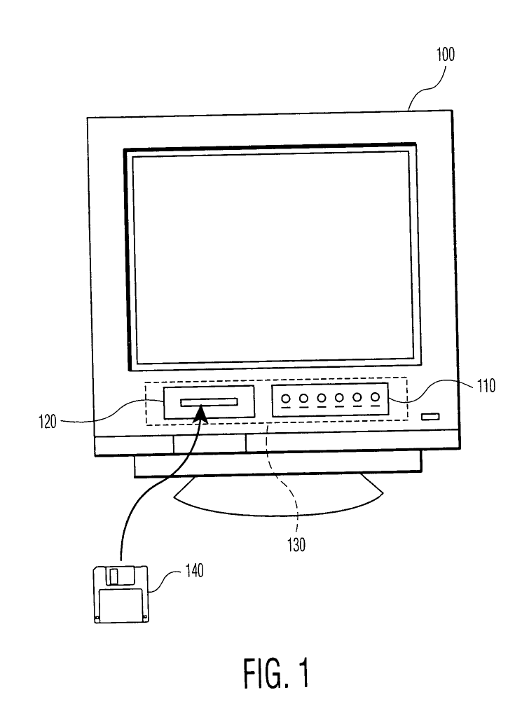

Referring to FIG. 1, a stand-alone monitor 100 is shown. The stand-alone monitor 100 is preferably a digital cathode-ray tube (CRT) display type, a liquid crystal display (LCD) or an electroluminescent display (such as a full color plasma display), to name a few. The invention may also be implemented in conjunction with an analog CRT monitor, TV, or a projection device as well, without realizing the improved picture quality offered by digital monitors. The term monitor will be used to generically describe all the above items hereinafter. The monitor 100 includes an interface 130, which is comprised of a reader 120 and a keypad 110. The reader 120 reads images stored on an electronic storage medium 140 (storage device hereinafter). The storage device 140 is currently available in many varieties, such as smart media, compact flash, mini-discs (MD, ZIP or PCMCIA), PCMCIA cards, memory sticks, or HDD modules, for example. The reader 120 may also be configured to read optical media storage devices 140, such as compact disks (CD), recordable CDs (CD-R), rewritable CDs (CD-RW), and digital versatile disks (DVD), for example. The reader 120 is designed to read the specific storage device 140 used. Additional readers 120 or multiple storage device type readers may be employed to read more than one storage device type.

The storage device 140 contains image files stored on the storage device 140 by a digital camera, scanner, camcorder with digital photograph capabilities, or by other image sources. For example, a user may take a series of photographs with a digital camera with a Compact Flash card installed therein. The Compact Flash card is then removed from the digital camera and inserted in the reader 120. The reader 120 reads the images from the Compact Flash card for display on the monitor 100.

The monitor 100 is also equipped with a keypad 110, to allow a user to navigate through the various images stored on the storage device 140. Using the keypad 110, a user may, for example, manipulate the images and data on the storage device 140 and display, move from one image to the next forward or backward, zoom in on a selected image, resize a selected image and scroll through the zoomed images. A user may also set the monitor 100 in a slide show mode to automatically sequence through the images on a periodic basis, switch between input modes (PC or storage device), display thumbnail views on the display, display textual information from the storage device, and manipulate the sequence of images, resize images, rotate images, mirror images, etc. These functions can be assigned to the buttons of the keypad 110, or accessed by navigating through menus on the screen via the buttons of the keypad 110.

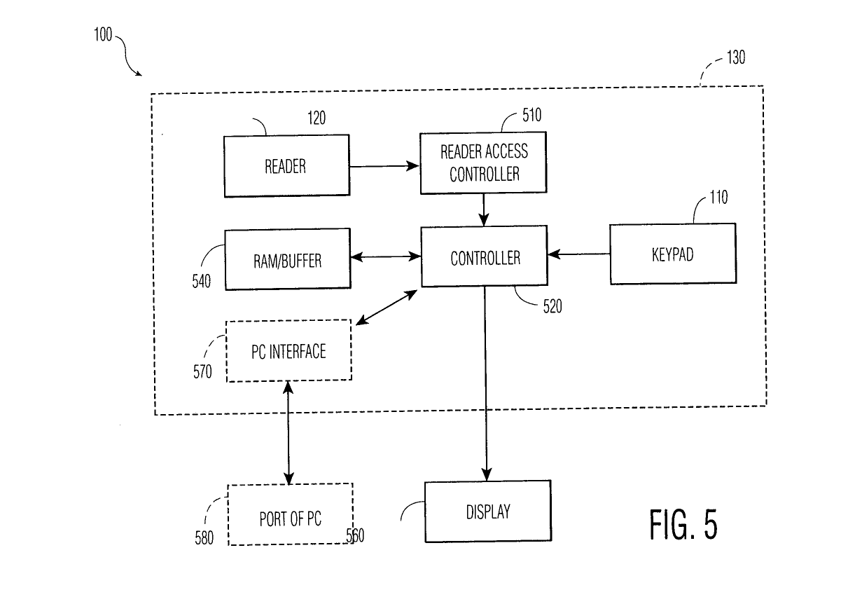

With reference to FIG. 5, a block diagram is shown illustrating an example of the interface 130 of FIG. 1 in greater detail. In FIG. 5, the interface 130 interfaces with a display 560 portion of monitor 100 in accordance with the present invention. The interface 130 is integrated within the monitor and includes reader 120, which reads the storage device 140 inserted into the reader by a user. The image data is read from the storage device 140 by the reader 120 under the control of the reader access controller 510 and supplied to a controller 520 for processing. The controller 520 is preferably realized within the hardware of current monitors. For example, the functions of the controller 520 are performed by sharing resources within a microprocessor and graphics scaler of the monitor 100, thereby reducing additional cost in accordance with an object of the present invention. The keypad 110, or another suitable user-input means, provides user input to the controller 520 to instruct the controller 520 to execute various routines corresponding to the user input. A RAM 540 allows temporary storage of processing information and image information. Here again, the RAM 540 is preferably realized by sharing resources within the frame buffer of the monitor 100. The controller 520 queues the image data to the RAM 540 for displaying on the display 560. Similarly, the keypad may be shared. That is, the keypad may also be used to perform other functions for the monitor, such as adjusting the display size and position, contrast, etc.

In operation, image data is read from the storage device 140 by the controller 520 via the reader 120 and the reader access controller 510 respectively. The controller 520, under the control of the keypad 110 and the corresponding commands invoked therein by a user, reads and processes the images and stores the processed images in the RAM 540. The images are periodically, or on demand via an instruction from the keypad 110, transferred sequentially to the RAM 540 for storage, then to the display 560 for display. A user initiates the data reading and controls the manipulation of the images on the display via the keypad 110.

The user may perform additional controls via the keypad 110. For example, the user may delete stored images, input commands that select multiple images to be simultaneously displayed, etc.

The reader access controller 510 may be part of controller 520. As noted above, the image data is read from the storage device 140 by the reader 120 under the control of the reader access controller 510. Controller 520 and/or RAM 540 may be part of the controller for the display 560, in which case the controller 520 processes the image data into a format that is compatible with the display input requirements, for example, the display drivers. If controller 520 is separate from the controller for the display 560, then controller 520 processes the image data into a format that is compatible with the input requirements of the display controller.

The interface 130 may optionally include a PC interface 570, such as USB, serial, IEEE 1394, etc., to transfer images processed by the controller 520 to a port 580 of a PC. The images may then be archived by the PC for later retrieval, printing, and viewing.

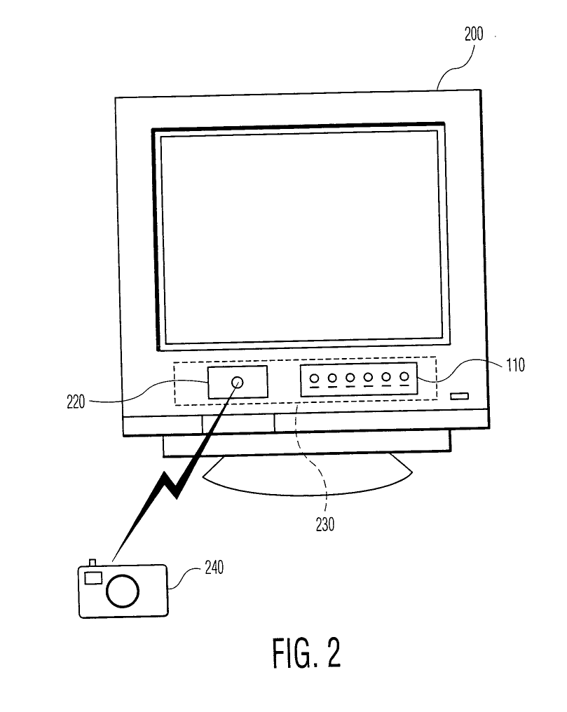

Referring now to FIG. 2, a monitor 200 is shown in accordance with another embodiment of the present invention. In FIG. 2, an interface 230 includes a wireless communication port 220 and the keypad 110. The wireless communication port 220 receives digital signals transmitted by a digital camera 240 (or scanner, or camcorder with digital photograph capabilities, a laptop computer or another image source). The digital signals may comprise initial communication setup, the transfer of image data stored in the camera, and user initiated control commands allowing a user to remotely control the monitor 200 from the camera 240.

The digital signals may be transmitted via radio frequency (RF), infrared (IR), or any other suitable communication method known in the art. In any case, a transmitter in the camera 240 and a receiver in the wireless communication port 220 communicate via a common communication method and protocol, allowing transfer of the images to the monitor 200 for convenient viewing by the user.

The keypad 110 allows local user control over the display of the images as described above. However, in this embodiment, it is also possible to control the monitor 200 remotely from the camera 240 via the wireless communications. That is, a user may initiate the data reading and control the manipulation of the images on the display via the camera 240.

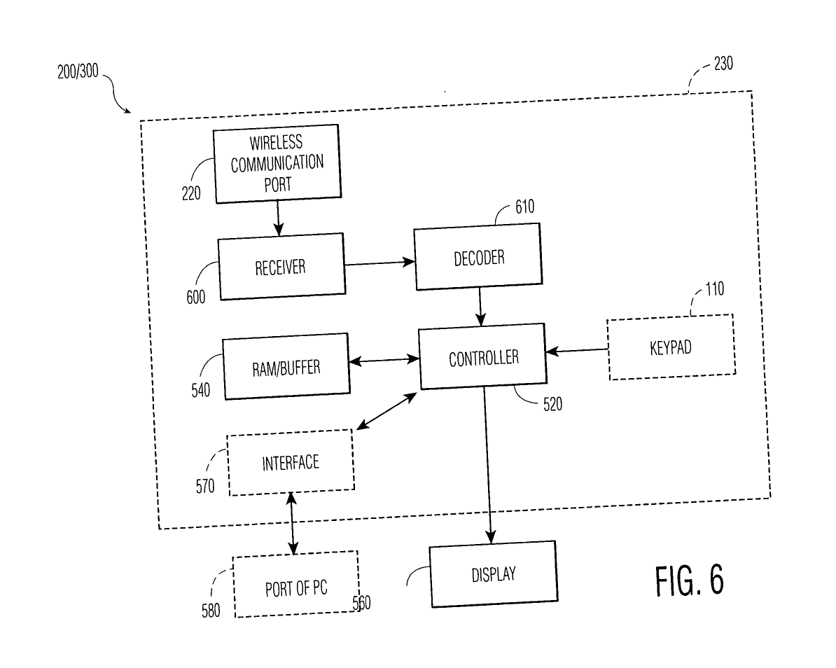

With reference now to FIG. 6, a block diagram is shown illustrating an exemplary embodiment of the interface 230 of FIG. 2. In FIG. 6, the interface 230 is integrated within the monitor and controls a display 560 in accordance with the present invention.

The interface 230 includes a receiver 600, which receives digital signals from a wireless image source 240 via the wireless communications port 220. The received digital signals are decoded by a decoder 610. The decoded signal is processed by the controller 520. A keypad 110 provides user control over the controller 520 to instruct the controller 520 to execute various routines corresponding to the user input at the keypad 110. A RAM 540 allows temporary storage of processing information and image information. The controller 520 queues the image data to the RAM 540 for displaying on the display 560. The controller 520 and the RAM 540 is preferably realized by sharing resources within a microprocessor, scaler and frame buffer of the monitor 200.

In operation, data is received from the wireless image source 240 by the receiver 600 via the wireless communication port 220. The received data is decoded in the decoder 610 and supplied to the controller 520. The controller 520, under the control of the keypad 110 and the corresponding commands invoked therein by a user, processes the data and stores processed images in the RAM 540. The controller 520 transfers the images sequentially to the RAM 540 for storage, then to the display 560 for display. The controller 520 may also receive remote user commands within the data received from the camera 240 via the wireless communications port 220, the receiver 600, and the decoder 610, in addition to receiving them from the keypad 110. In that case, a user may initiate the image transfer and control the sequencing and sizing of the images on the display via the keypad 110 or the camera 240.

As in the case of the prior interface (of FIG. 5), the user may perform controls via the keypad. For example, the user may delete stored images, input commands that select multiple images to be simultaneously displayed, etc. In addition, the decoder 610 may be part of controller 520. Controller 520 and/or RAM 540 may be part of the controller for the display 560, in which case the controller 520 processes the image data into a format that is compatible with the display input requirements, for example, the display drivers. If controller 520 is separate from the controller for the display 560, then controller 520 processes the image data into a format that is compatible with the input requirements of the display controller.

The interface 230 may optionally include a PC interface 570 to transfer images provided by the controller 520 to a port 580 of a PC. The images may then be archived by the PC for later retrieval, printing, and viewing.

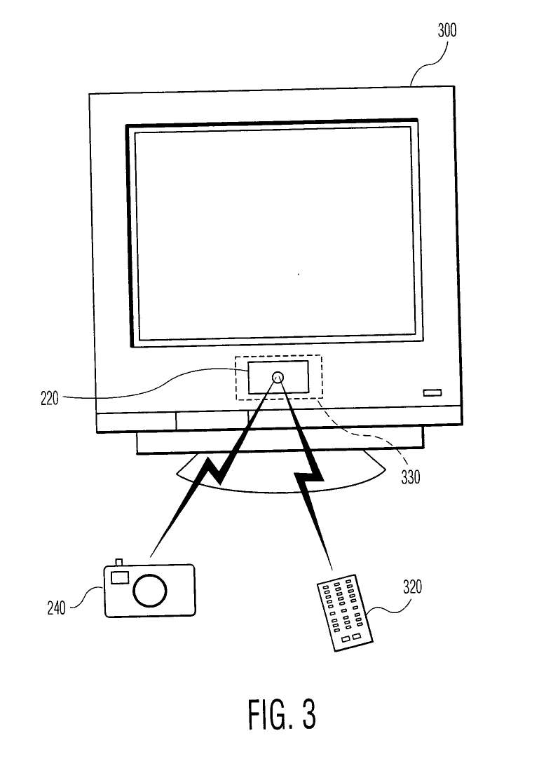

With reference now to FIG. 3, an alternative embodiment of the present invention is shown. In FIG. 3, the interface 330 includes the wireless communication port 220 to communicate with the camera 240 as described above for image transfer and control. A remote controller 320 provides control over the monitor 300 to perform the functions described above with reference to the keypad 110. The remote controller 320 communicates wirelessly with wireless communication port 220. Control may also be obtained at the camera via the wireless communication. The communication method may be RF, IR, or another suitable method known in the art. The other internal details and operation of interface 330 are, for example, analogous to that shown in FIG. 6 and described above. The keypad 110 of FIG. 6 is optional in this embodiment, since a remote controller 320 is employed.

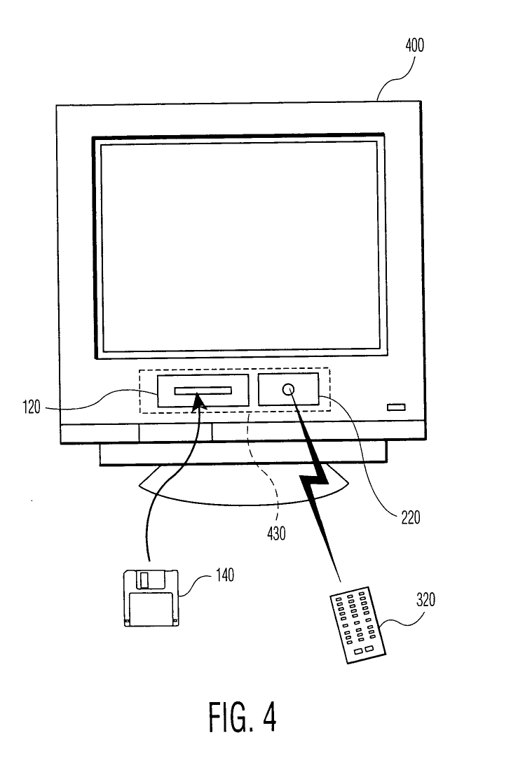

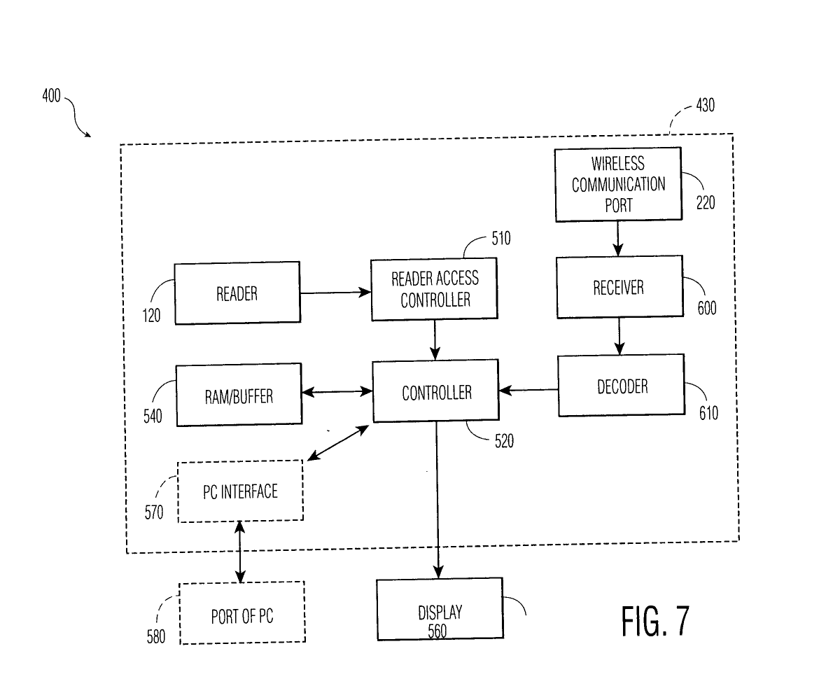

Referring now to FIG. 4, yet another embodiment of the present invention is shown. In FIG. 4, the interface 430 includes the reader 120 to facilitate reading images stored on a storage device 140 as described above with reference to FIG. 1 and the wireless communication port 220. A remote controller 320 provides remote control over the monitor 300 as described above with respect to FIG. 3. The other internal details and operation of interface 430 are, for example, analogous to that shown in FIG. 5, with the keypad replaced with the wireless communications port 220, receiver 600, and decoder 610 of FIG. 6 to provide control via the remote controller 320. This configuration is illustrated in FIG. 7.

The embodiments of FIGS. 3 and 4 above may also optionally include capabilities to transfer the images to a PC for archiving, as discussed above. The connection is preferably via a cable connected to a port of the PC.

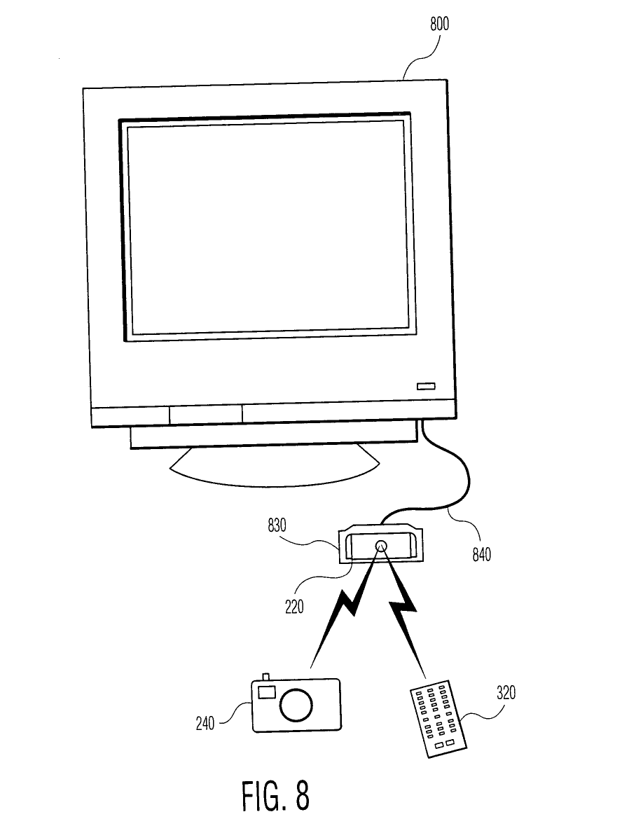

With reference now to FIG. 8, an alternative embodiment of the present invention is shown. In FIG. 8, the present invention is adapted to work with either a conventional or specialized monitor 800 via a cable 840. An interface 830 includes the wireless communication port 220 to communicate with the camera 240 and a wireless remote controller 320 as described above for image transfer and control. The keypad (not shown) may optionally be incorporated with the interface 830 to provide local control over the monitor 800. Control may also be obtained at the camera 240 and/or wireless remote controller 320 via the wireless communication. The communication method may be RF, IR, or another suitable method known in the art. The other internal details of interface 830 are, for example, analogous to that shown in FIG. 6 and described above. The display 560 of FIG. 6 corresponds to monitor 800 in this embodiment, and the interface 230 corresponds to interface 830, with the interface 230 (interface 830) being connected to display 560 (monitor 800) via the cable 840.

Here, the monitor 800 may be a conventional computer monitor connected via the conventional VGA cable. The interface 830 may be connected only to the monitor 800, or to both a PC (not shown) and the monitor 800. In the later case, the interface 830 shares the monitor with the PC via an in-line arrangement. That is, a second cable is connected between the interface 830 and the PC and the video signals from the PC are allowed to pass through the interface 830 directly to the monitor (or buffered within the interface, then passed on) when the interface 830 is inactive or dormant. When a user activates the interface 830, by initiating the functions therein, the line to the PC is deactivated, allowing the interface 830 to assume sole control over the monitor 800.

Alternatively, the monitor 800 may be specialized, allowing enhanced communications between the interface 830 and monitor 800, in addition to the video signals. For example, the images may be downloaded to the monitor 800 for storage.

The monitor 800 may also be a television. In such a case a video cable may be supplied, such as RCA or S-video. In such a case, the controller 520 of interface 830 is operative to supply video signals in a suitable format. The user operation of interface 830 is otherwise the same.

Accordingly, a monitor (or interface) in accordance with the present invention allows a user to view high-resolution photographic images directly on a monitor, to enlarge the photograph for viewing without the need of a PC. Consequently, a user is not required to boot up a PC and load specialized software before transferring and viewing the images on the monitor, thereby conveniently saving the user time, and the added cost of a PC. Additionally, a user may use a monitor designed to incorporate the interface of the present invention while sharing hardware resources within the monitor, and need not purchase expensive dedicated viewing devices for this purpose.

While the present invention has been described in detail with reference to the preferred embodiments, they represent mere exemplary applications. Thus, it is to be clearly understood that many variations can be made by anyone having ordinary skill in the art while staying within the scope and spirit of the present invention as defined by the appended claims.

What is claimed is:

1. A stand-alone monitor having an interface comprising:
a storage medium reader that reads a digital image stored on a storage medium;
a controller that processes and transfers the read digital image for display on a display screen of the stand-alone monitor; and
a user-interface operable to enable issuing a command to the controller to control the reading and display of the digital image on the display screen.

2. The monitor of claim 1, wherein the digital image is read by the storage medium reader and transferred to an image buffer of the stand-alone monitor for storage and for display on the display screen.

3. The monitor of claim 2, wherein at least the controller or the image buffer is also used to perform a task, unrelated to the interface, within the stand-alone monitor.

4. The monitor of claim 1, wherein the controller processes the read digital image into a format that is compatible with the signal input of the display.

5. The monitor of claim 1, wherein the user-interface enables the user to manipulate at least the image displayed or the data stored on the storage medium.

6. The monitor of claim 5, wherein the user-interface enables the user to perform at least one of following manipulations of the image: deleting or protecting the data stored on the storage medium, or sequencing the display of multiple images, or resizing the image, or rotating the image, or mirroring the image, or displaying textual information about the image, or displaying a thumbnail view of the image.

7. The monitor of claim 6, wherein the at least one manipulation is performed via on-screen menu selection through the user-interface.

8. The monitor of claim 1, wherein the display screen for displaying the digital image is selected from the group consisting of a cathode-ray tube display (CRT), a digital CRT, a liquid crystal display (LCD), a TV, a projection device, and an electroluminescent display (ELD).

9. The monitor of claim 1, wherein the storage medium is selected from the group consisting of smart media, compact flash memory, mini-disc, zip disc, memory stick, PCMCIA (Personal Computer Memory Card International Association) card, compact disk (CD), recordable CD (CD-R), rewritable CD (CD-RW), digital versatile disk (DVD) and HDD.

10. The monitor of claim 1, wherein the storage medium reader is capable of reading two or more different storage media types.

11. A stand-alone monitor having an interface comprising:
a wireless communications port that wirelessly communicates with a wireless image source via a common method and protocol to receive a digital image transmitted by the wireless image source to the interface; and
a controller that processes and transfers the received digital image for display on a display screen of the stand-alone monitor.

12. The monitor of claim 11, further comprising:
a user-interface enabling a user to issue a command to the controller to control the receipt and display of the digital image on the display screen.

13. The monitor of claim 11, wherein the wireless communication port communicates with the wireless image source using an infrared (IR) signal as the common method and protocol.

14. The monitor of claim 11, wherein the wireless communication port communicates with the wireless image source using a radio frequency (RF) signal as the common method an protocol.

15. The monitor of claim 11, wherein the wireless image source is selected from the group consisting of a digital camera, a scanner, a laptop computer and a camcorder.

16. The monitor of claim 11, further comprising a remote control device for wirelessly communicating with the wireless communication port to issue a command to the controller for control of receipt and display of the digital image on the display screen.

17. The monitor of claim 11, wherein the interface is located in an enclosure separate from the stand-alone monitor and communicates with the stand-alone monitor to display and manipulate an image via a cable.

18. The monitor of claim 17, wherein the interface also communicates with a PC via a second cable, said interface being operative to forward a video signal from the PC to the monitor in a PC mode and to forward the video signal from the interface to the monitor in an interface mode.

19. An interface for a stand-alone monitor comprising:
a storage medium reader that reads a digital image stored on a storage medium;
a wireless communications port that wirelessly communicates with a remote control device via a common method and protocol to receive a command transmitted by the remote control device to the interface;
a receiver operable to receive the command from the wireless communications port;
a decoder that decodes the command supplied by the receiver; and
a controller that processes and executes the decoded command, and processes and transfers the read digital image for display on a display screen of the stand-alone monitor.
